(19) United States
(12) Patent Application Publication
(10) Pub. No.: US 2026/0287906 A1
(43) Pub. Date: Sep. 24, 2026

(54) HEAD-MOUNTED DEVICE HAVING LENS INTEGRATED WITH FRAME

(71) Applicant: Meta Platforms Technologies, LLC, Menlo Park, CA (US)

(72) Inventor: Sarat Babu, Redmond, WA (US)

(21) Appl. No.: 19/088,573

(22) Filed: Mar. 24, 2025

(51) Int. Cl. G02B 27/01

(52) U.S. Cl. CPC G02B 27/0176; G02B 2027/0152; G02B 2027/0178

(57) ABSTRACT

A head-mounted display (HMD) includes a structural frame, a waveguide, an eye-side lens, and a world-side lens. The waveguide is configured to direct display light to an eyebox region. The eye-side lens or the world-side lens is integrated into the structural frame as a molded contiguous refractive material. The eye-side lens has a first optical power configured to focus the display light to the eyebox region. The world-side lens has a second optical power and the combination of the first optical power and the second optical power focuses scene-light to the eyebox region. The waveguide is disposed between the eye-side lens and the world-side lens.

### TECHNICAL FIELD

This disclosure relates generally to head-mounted devices, and in particular to optical integration.

### BACKGROUND INFORMATION

Head mounted-device such as smartglasses and head-mounted displays (HMD) typically have one or more lenses. It is desirable for head-mounted devices to become lighter and thinner while also being structurally sound. Lighter devices are more comfortable to wear for longer periods of time and thinner devices improve aesthetics in addition to providing designers with greater design freedom. Of course, the structural integrity of devices that include electronics and/or optical components is also a high priority.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head-mounted display (HMD) that includes eyepieces.

FIGS. 2A-2C illustrate an eyepiece including a waveguide for directing display light to an eyebox region.

FIG. 3A illustrates a structure that includes eye-side lenses integrated with a structural frame of an HMD, in accordance with aspects of the disclosure.

FIG. 3B illustrates a top view of the structure of FIG. 3A, in accordance with aspects of the disclosure.

FIG. 3C illustrates a structure having waveguides included with the structure of FIG. 3B, in accordance with aspects of the disclosure.

FIG. 3D illustrates a structure having world-side lenses included with the structure of FIG. 3C, in accordance with aspects of the disclosure.

FIG. 3E illustrates an assembly for an HMD having one or more aesthetic covers added to the structure of FIG. 3D, in accordance with aspects of the disclosure.

FIG. 3F illustrates a head-mounted display (HMD) including the assembly of FIG. 3E, in accordance with aspects of the disclosure.

FIG. 4A illustrates a structure that includes world-side lenses integrated with a structural frame of an HMD, in accordance with aspects of the disclosure.

FIG. 4B illustrates a top view of the structure of FIG. 4A, in accordance with aspects of the disclosure.

FIG. 4C illustrates a structure having waveguides included with the structure of FIG. 4B, in accordance with aspects of the disclosure.

FIG. 4D illustrates a structure having eye-side lenses included with the structure of FIG. 4C, in accordance with aspects of the disclosure.

FIG. 4E illustrates an assembly for an HMD having one or more aesthetic covers added to the structure of FIG. 4D, in accordance with aspects of the disclosure.

FIG. 4F illustrates an HMD 400 including the assembly of FIG. 4E, in accordance with aspects of the disclosure.

### DETAILED DESCRIPTION

Embodiments of head-mounted displays (HMD) having one or more lenses integrated with the structural frame of the HMD are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm – 700 nm. Non-visible light may be defined as light having wavelengths that are outside the visible light range, such as ultraviolet light and infrared light. Infrared light having a wavelength range of approximately 700 nm – 1 mm includes near-infrared light. In aspects of this disclosure, near-infrared light may be defined as having a wavelength range of approximately 700 nm - 1.6 µm.

In aspects of this disclosure, the term “transparent” may be defined as having greater than 90% transmission of light. In some aspects, the term “transparent” may be defined as a material having greater than 90% transmission of visible light.

Existing techniques for building a head-mounted display (HMD), such as augmented reality (AR) glasses, includes securing an eyepiece to a frame. The eyepiece generally includes a waveguide to direct display light to and eyebox and at least one lens. Often, the eyepiece includes an eye-side lens for focusing virtual images included in the display light to the eye of a user. The waveguide is often disposed between the eye-side lens and a world-side lens configured to focus scene light (from the external environment) to the eye of the user. In some configurations, a display engine is also coupled to the waveguide so that the display engine and the eyepiece are combined into a single component that can be coupled to the frames of the glasses. In implementations of the disclosure, the structural frame of an HMD is integrated with a lens of the HMD.

In an implementation, the structural frame is integrated with an eye-side lens of a head-mounted display. The eye-side lens is configured to focus display light from a waveguide to an eyebox region. The eye-side lens is integrated with the structural frame as a molded contiguous refractive material. The integrated eye-side lens and structural frame may have a mounting feature to position/align the waveguide and/or a world-side lens during an assembly process. In some implementations, the structure frame is integrated with two eye-side lenses (one for each eye).

In an implementation, the structural frame is integrated with a world-side lens of a head-mounted display. The world-side lens is configured to focus scene light to an eyebox region. The world-side lens is integrated with the structural frame as a molded contiguous refractive material. The integrated world-side lens and structural frame may have a mounting feature to position/align the waveguide and/or an eye-side lens during an assembly process. In some implementations, the structure frame is integrated with two world-side lenses (one for each eye).

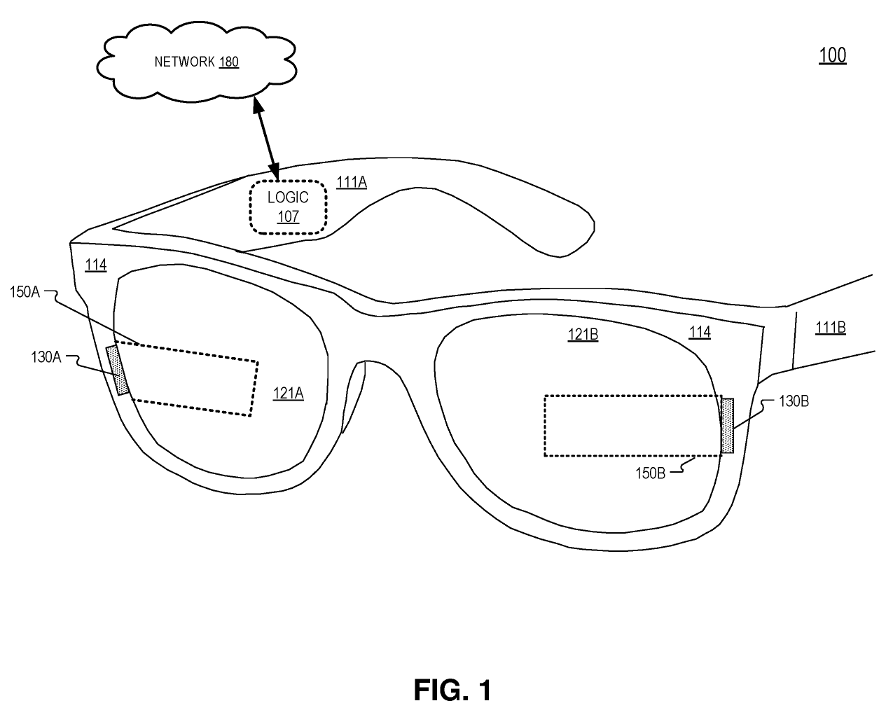

Integrating the eye-side lens or world-side lens with the structural frame provides better structural integrity while also allowing for a lighter and thinner eye-side lens. Integrating the eye-side or world-side lens with the structural frame may also provide simpler and less costly manufacturing processes. Furthermore, robustness of the HMD may be further enhanced from potentially harmful drops from heights. Yet another potential advantage of the disclosure includes allowing for better sealing of the device from environmental contaminants such as dust and liquids. These and other embodiments are described in more detail in connection with FIGS. 1-4F.

FIG. 1 illustrates a head-mounted display (HMD) 100 that includes eyepieces 121A and 121B. HMD 100 includes frame 114 coupled to arms 111A and 111B. Eyepieces 121A and 121B are mounted to frame 114. Eyepieces 121A and 121B may include a prescription lens matched to a particular user of HMD 100. The illustrated HMD 100 is configured to be worn on or about a head of a wearer of HMD 100.

In the HMD 100 illustrated in FIG. 1, each eyepiece 121A/121B includes a waveguide 150A/150B to direct image light generated by displays 130A/130B to an eyebox area for viewing by a user of HMD 100. Displays 130A/130B may include a beam-scanning display or a liquid crystal on silicon (LCOS) display for directing display light to a wearer of HMD 100 to present virtual images, for example.

Eyepieces 121A and 121B may appear transparent or semi-transparent to a user to facilitate augmented reality or mixed reality to enable a user to view scene light from the environment around them while also receiving display light directed to their eye(s) by, for example, by waveguides 150. Eyepieces 121A and 121B may include two or more optical layers for different functionalities such as display, eye-tracking, and/or optical power. In some embodiments, display light from display 130A or 130B is only directed into one eye of the wearer of HMD 100. In an embodiment, both displays 130A and 130B are used to direct display light into waveguides 150A and 150B, respectively.

Frame 114 and arms 111 may include supporting hardware of HMD 100 such as processing logic 107, a wired and/or wireless data interface for sending and receiving data, graphic processors, and one or more memories for storing data and computer-executable instructions. Processing logic 107 may include circuitry, logic, instructions stored in a machine-readable storage medium, ASIC circuitry, FPGA circuitry, and/or one or more processors. In one embodiment, HMD 100 may be configured to receive wired power. In one embodiment, HMD 100 is configured to be powered by one or more batteries. In one embodiment, HMD 100 may be configured to receive wired data including video data via a wired communication channel. In one embodiment, HMD 100 is configured to receive wireless data including video data via a wireless communication channel. Processing logic 107 may be communicatively coupled to a network 180 to provide data to network 180 and/or access data within network 180. The communication channel between processing logic 107 and network 180 may be wired or wireless.

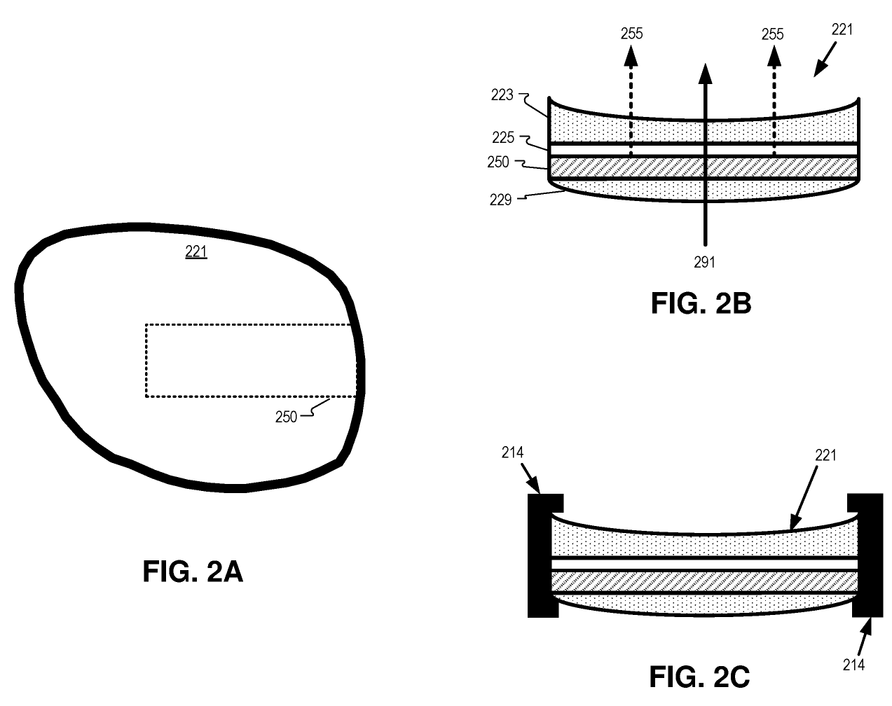

FIG. 2A illustrates an example eyepiece 221 including a waveguide 250 for directing display light to an eyebox region.

FIG. 2B illustrates a top view of the example eyepiece 221. In the illustrated example, eyepiece 221 includes an eye-side lens 223, a waveguide layer 227, and a world-side lens 229. An eye-tracking layer 225 may also be included in eyepiece 221. In FIG. 2B, eye-tracking layer 225 is disposed between eye-side lens 223 and waveguide layer 227. Eye-tracking layer 225 may include light sources to illuminate the eyebox with near-infrared light. Eye-tracking layer 225 may include an optical combiner configured to receive return near-infrared light reflecting/scattering from the eyebox region and redirect the return light to an eye-tracking camera (not particularly illustrated) of HMD 100.

Waveguide layer 227 is configured to direct display light 255 to the eyebox region. Display light 255 includes virtual images. Eye-side lens 223 is configured to focus the display light 255 to the eyebox region so that the user can view the virtual images included in display light 255. A display engine (not particularly illustrated) may be included in an HMD such as HMD 100 to provide the display light to the waveguide layer 227. The display engine may be manufactured with the rest of eyepiece 221 as a single part that is installed into a frame of the HMD.

FIG. 2C illustrates eyepiece 221 being installed into a structural frame 214 of an HMD. Structural frame 214 may have an eye-side portion and a world-side portion that sandwich eyepiece 221 between the eye-side portion and the world-side portion, in order to secure eyepiece 221 with frame 214 during an assembly process.

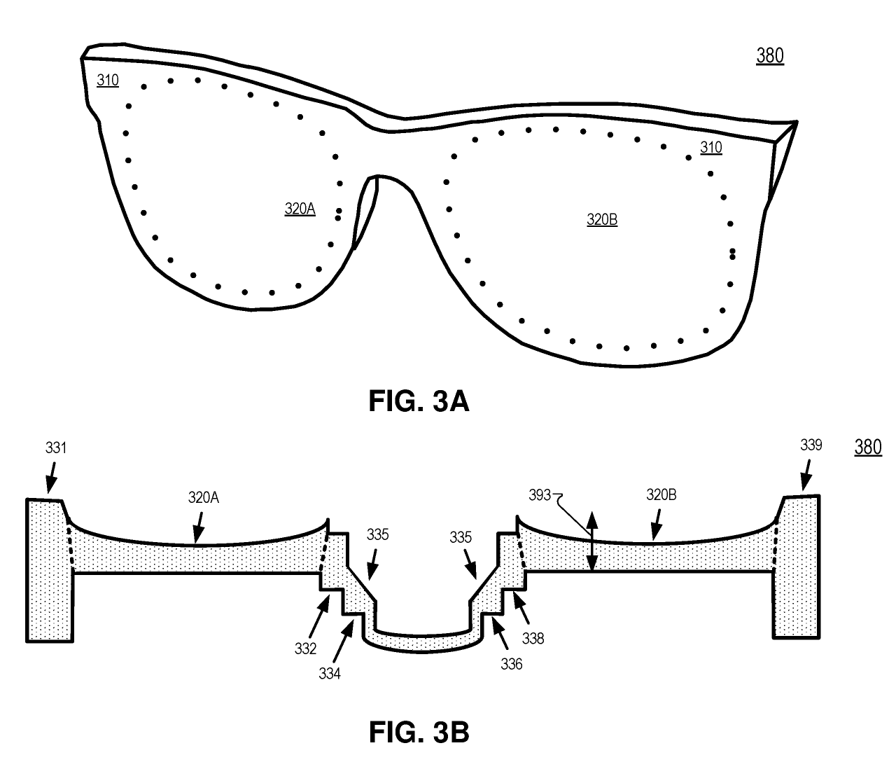

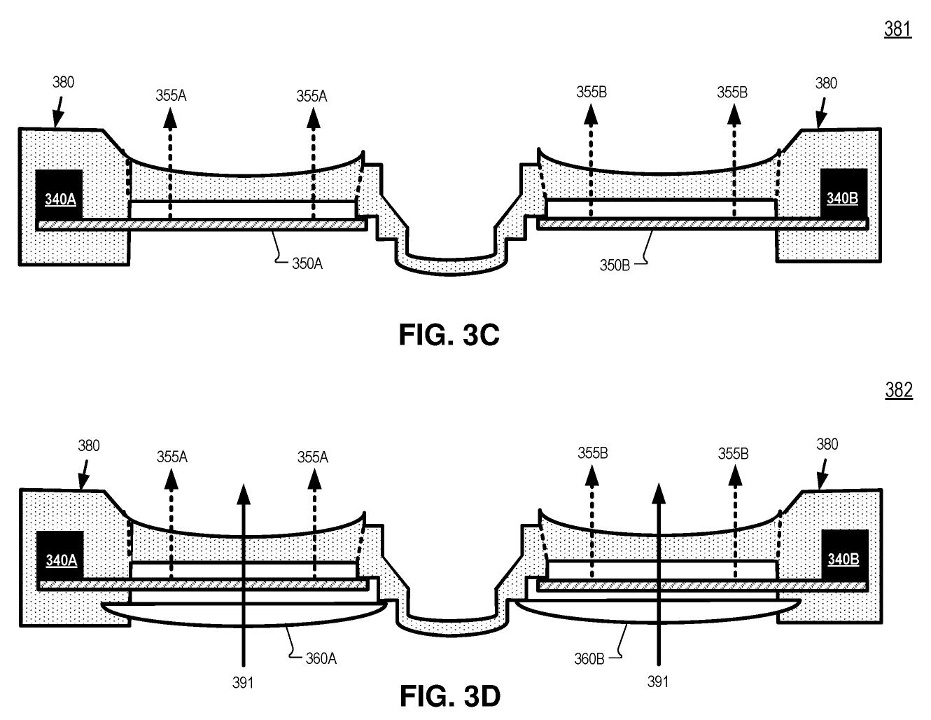

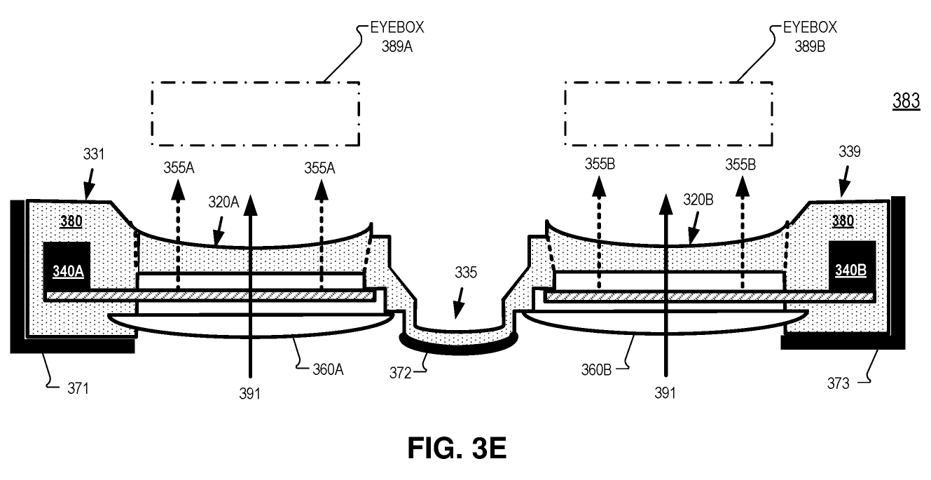

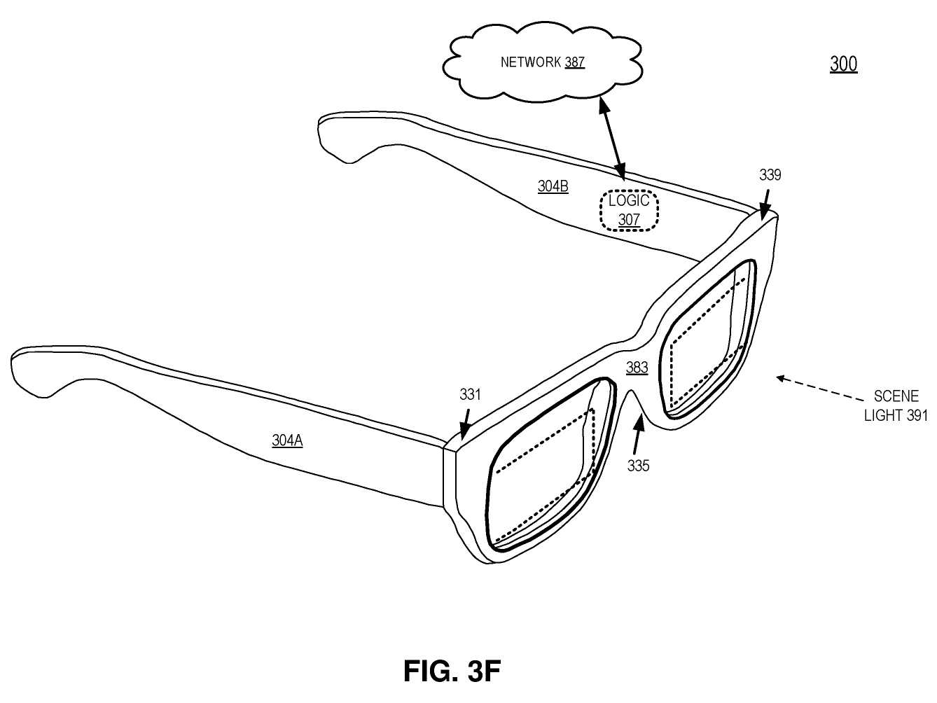

In contrast to the examples of FIG. 2A-2C, FIG. 3A illustrates a structure 380 that includes eye-side lenses 320A and 320B integrated with a structural frame 310, in accordance with aspects of the disclosure. Eye-side lenses 320A and 320B and structural frame 310 are a contiguous refractive material, in the implementation of FIG. 3B. The eye-side lenses 320A and 320B are drawn with dotted lines to show the approximate region they occupy while also indicating their integration with at least a portion of a structural frame 310. In various implementations, one or more of the eye-side lenses 320A and/or 320B are integrated with just a portion of frame 310 instead of the whole frame 310 that is illustrated in FIG. 3A.

The example implementations of FIGS. 3A-3F are a stark departure from FIGS. 2A-2C in that eye-side lenses 320A and 320B are integrated with structural frame 310 rather than eye-side lens 223 being assembled with the rest of eyepiece 221 and then installing (e.g. sandwiching) the eyepiece 221 within frame 214 illustrated in FIG. 2. The potential advantages of the implementations of FIGS. 3A-3F include increase rigidity, thinner form-factor, lighter form-factor, fewer assembly steps, and increased robustness of the device against damages from drops. Furthermore, the implementations of FIGS. 3A-3F also facilitate an improved sealing of the optical components from contaminants such as dust, dirt, and moisture.

FIG. 3B illustrates a top view of structure 380, in accordance with aspects of the disclosure. Structure 380 includes a first temporal side 331 of structural frame 310, a nasal portion 335 of structural frame 310, and a second temporal side 339 of structural frame 310. As shown in FIGS. 3A and 3B, the structural frame 310 may extend to a temporal side of an HMD and extend to a nasal portion of the HMD.

Eye-side lens 320A is disposed between first temporal side 331 of structural frame 310 and the nasal portion 335 of the structural frame 310. In the implementation of FIG. 3B, eye-side lens 320A is contiguous with first temporal side 331 and nasal portion 335. In some implementations, eye-side lens 320A is integrated with, and contiguous with, either the first temporal side 331 of the structural frame 310 or the nasal portion 335 of structural frame 310. In some implementations, the eye-side lens 320A is molded into a contiguous part with all or a portion of structural frame 310 by providing an optically transparent refractive material to a mold that includes the desired shape and curvature of eye-side lens 320A. Dimension 393 illustrates a thickness dimension of eye-side lens 320B. Dimension 393 may be 0.8 mm or thinner, in some implementations. Dimension 393 may be 0.6 mm or thinner, in some implementations. Eye-side lens 320A may have similar thickness dimensions.

Eye-side lens 320B is disposed between second temporal side 339 of structural frame 310 and the nasal portion 335 of the structural frame 310. In the implementation of FIG. 3B, eye-side lens 320B is contiguous with second temporal side 339 and nasal portion 335. In some implementations, eye-side lens 320B is integrated with, and contiguous with, either the second temporal side 339 of the structural frame 310 or the nasal portion 335 of structural frame 310. In an implementation, eye-side lens 320A and eye-side lines 320B are integrated with, and contiguous with, just the nasal portion 335 of the structural frame. In some implementations, the eye-side lens 320B is molded into a contiguous part with all or a portion of structural frame 310 by providing an optically transparent refractive material to a mold that includes the desired shape and curvature of eye-side lens 320B. In some implementations, structure 380 is fabricated using a single mold.

FIG. 3B illustrates that the eye-side lens 320A integrated with all or a portion of structural frame 310 may include a mounting feature 332 for positioning a waveguide and/or a mounting feature 334 to position a world-side lens. Similarly, eye-side lens 320B integrated with all or a portion of structural frame 310 may include a mounting feature 338 for positioning a waveguide and/or a mounting feature 336 to position a world-side lens.

FIG. 3C illustrates a structure 381 having waveguides 350A and 350B included with structure 380, in accordance with aspects of the disclosure. Waveguide 350A is disposed on mounting feature 332. Mounting feature 332 may include an optical bench feature configured to align waveguide 350A. Waveguide 350A may be adhered to the mounting feature 332 included in the nasal portion 335 of the structural frame 310. Waveguide 350A may be optically coupled to receive display light generated by display engine 340A and direct the display light to an eyebox region as display light 355A in order to present a virtual image to a user. In some implementations, waveguide 350A and display engine 340A form a display assembly that is assembled as a single part into structure 381. Structure 381 may include a cavity sized to hold and secure display engine 340A and waveguide 350A. Eye-side lens 320A is configured to have an optical power configured to focus the display light 355A to an eyebox region. Eye-side lens 320A may be a planar-concave lens and the curvature of the concave (eye-side) portion of the planar-concave lens may provide the optical power. The optical power of the eye-side lens may include a prescription optical power that is customized for the user, in some implementations.

Waveguide 350B is disposed on mounting feature 338. Mounting feature 338 may be an optical bench feature configured to align waveguide 350B. Waveguide 350B may be adhered to the mounting feature 338 included in the nasal portion 335 of the structural frame 310. Waveguide 350B may be optically coupled to receive display light generated by display engine 340B and direct the display light to an eyebox region as display light 355B in order to present a virtual image to a user. In some implementations, waveguide 350B and display engine 340B form a display assembly that is assembled as a single part into structure 381. Structure 381 may include a cavity sized to hold and secure display engine 340B and waveguide 350B. Eye-side lens 320B is configured to have an optical power configured to focus the display light 355B to an eyebox region. Eye-side lens 320B may be a planar-concave lens and the curvature of the concave (eye-side) portion of the planar-concave lens may provide the optical power. The optical power of the eye-side lens may include a prescription optical power that is customized for the user, in some implementations. The optical power of eye-side lens 320B may differ from the optical power of eye-side lens 320A.

FIG. 3D illustrates a structure 382 having world-side lenses 360A and 360B included with structure 381, in accordance with aspects of the disclosure. World-side lens 360A is disposed on mounting feature 334. Mounting feature 334 may be an optical bench feature configured to align world-side lens 360A. World-side lens 360A may be adhered to the mounting feature 334 included in the nasal portion 335 of the structural frame 310. Waveguide 350A is disposed between eye-side lens 320A and world-side lens 360A, in FIG. 3D. Airgaps may exist between waveguide 350A and world-side lens 360A. Airgaps may exist between waveguide 350A and eye-side lens 320A. World-side lens 360A may be optically aligned to share a common optical axis with eye-side lens 320A.

World-side lens 360B is disposed on mounting feature 336. Mounting feature 336 may be an optical bench feature configured to align world-side lens 360B. World-side lens 360B may be adhered to the mounting feature 336 included in the nasal portion 335 of the structural frame 310. Waveguide 350B is disposed between eye-side lens 320B and world-side lens 360B, in FIG. 3D. Airgaps may exist between waveguide 350B and world-side lens 360B. Airgaps may exist between waveguide 350B and eye-side lens 320B. World-side lens 360B may be optically aligned to share a common optical axis with eye-side lens 320B.

FIG. 3E illustrates an assembly 383 for a head-mounted display having one or more aesthetic covers added to structure 382, in accordance with aspects of the disclosure. FIG. 3E includes aesthetic cover piece 371 over a first temporal side 331 of structure 380, nasal aesthetic piece 372 over nasal portion 335 of structure 380, and aesthetic cover piece 373 over a second temporal side 339 of structure 380. In the illustration of FIG. 3E, the aesthetic covers 371, 372, and 373 are not disposed over the eye-side lenses 320A/320B nor the world-side lenses 360A/360B so that the covers don’t block scene light 391 from propagating through the lenses. In some implementations, the aesthetic covers 371, 372, and/or 373 may include a coating or a paint. In some implementations, the aesthetic covers 371, 372, and/or 373 may simply be a coating or paint.

In FIG. 3E, world-side lens 360A may have an optical power that combines with the optical power of eye-side lens 320A to focus scene light 391 to an eyebox region 389A. In some implementations, the optical power of the eye-side lens 320A offsets the optical power of world-side lens 360A so that no optical power is imparted to scene light 391 after propagating through both world-side lens 360A and eye-side lens 320A. World-side lens 360B may have an optical power that combines with the optical power of eye-side lens 320B to focus scene light 391 to an eyebox region 389B. In some implementations, the optical power of the eye-side lens 320B offsets the optical power of world-side lens 360B so that no optical power is imparted to scene light 391 after propagating through both world-side lens 360B and eye-side lens 320B.

FIG. 3F illustrates a head-mounted display (HMD) 300 including assembly 383, in accordance with aspects of the disclosure. In FIG. 3F, foldable arms 304A and 304B are coupled to the temporal sides of the structural frame 310 of assembly 383. Assembly 383 and arms 304A and 304B may include supporting hardware of HMD 300 such as processing logic 307, a wired and/or wireless data interface for sending and receiving data, graphic processors, and one or more memories for storing data and computer-executable instructions. Processing logic 307 may include circuitry, logic, instructions stored in a machine-readable storage medium, ASIC circuitry, FPGA circuitry, and/or one or more processors. In one embodiment, HMD 300 may be configured to receive wired power. In one embodiment, HMD 300 is configured to be powered by one or more batteries. In one embodiment, HMD 300 may be configured to receive wired data including video data via a wired communication channel. In one embodiment, HMD 300 is configured to receive wireless data including video data via a wireless communication channel. Processing logic 307 may be communicatively coupled to a network 387 to provide data to network 387 and/or access data within network 387. The communication channel between processing logic 307 and network 387 may be wired or wireless.

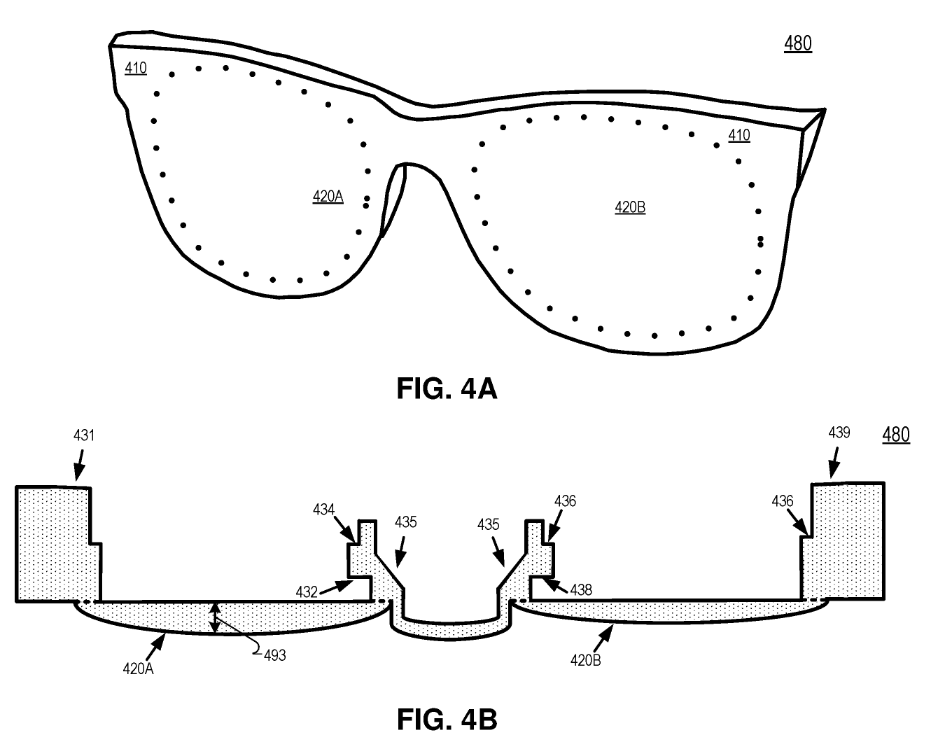

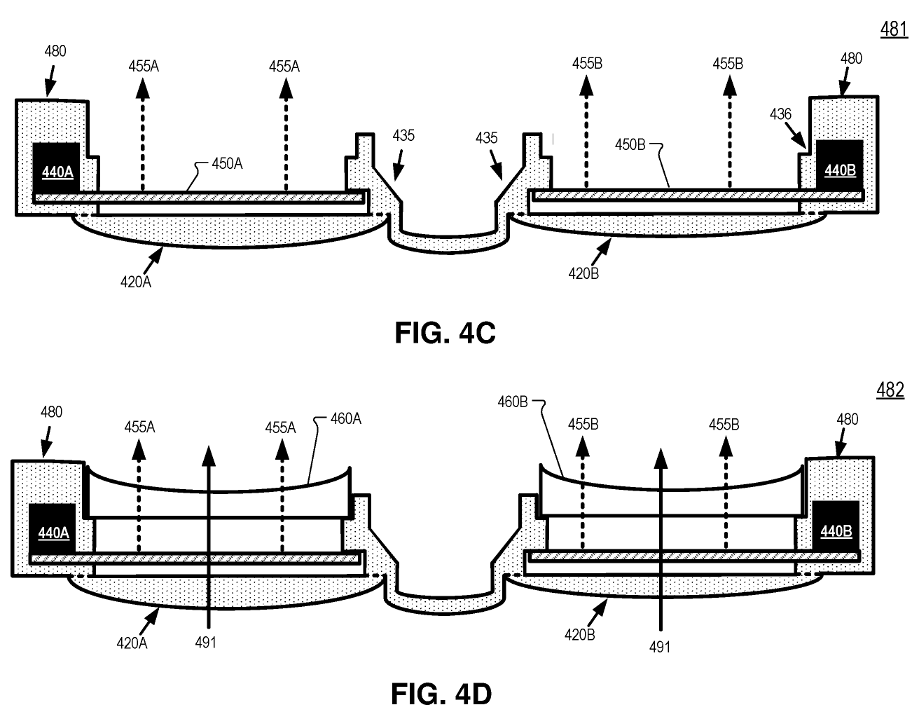

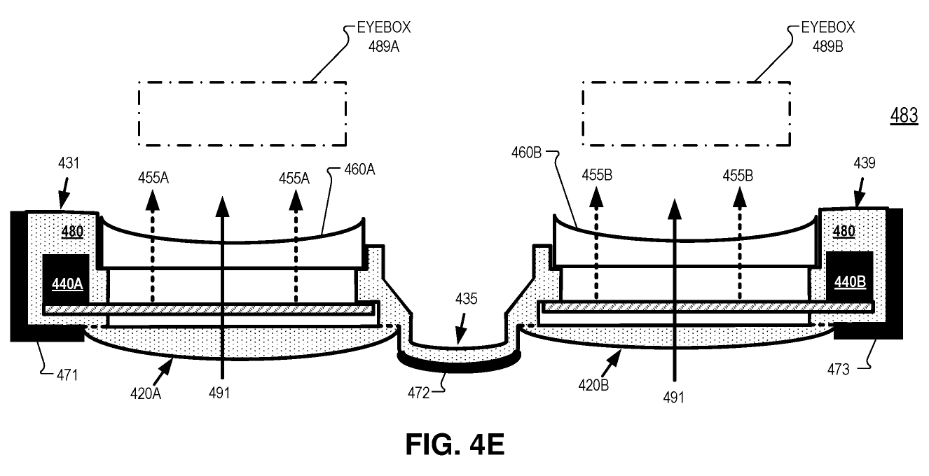

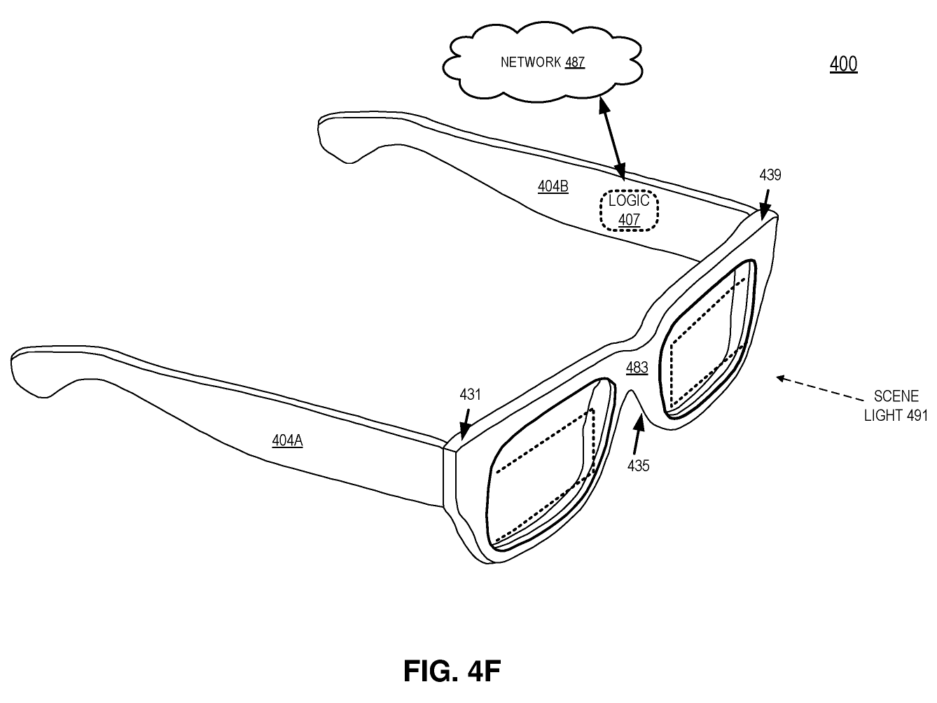

FIG. 4A illustrates a structure 480 that includes world-side lenses 420A and 420B integrated with a structural frame 410, in accordance with aspects of the disclosure. In FIGS. 4A-4F, the world-side lenses are integrated into the structural frame instead of having the eye-side lenses integrated into the structural frame, as in FIGS. 3A-3F. World-side lenses 420A and 420B and structural frame 410 are a contiguous refractive material, in the implementation of FIG. 4B. The world-side lenses 420A and 420B are drawn with dotted lines to show the approximate region they occupy while also indicating their integration with at least a portion of a structural frame 410. In various implementations, one or more of the world-side lenses 420A and/or 420B are integrated with just a portion of frame 410 instead of the whole frame 410 that is illustrated in FIG. 4A.

The example implementations of FIGS. 4A-4F are also a departure from FIGS. 2A-2C in that world-side lenses 420A and 420B are integrated with structural frame 410 rather than world-side lens 223 being assembled with the rest of eyepiece 221 and then installing (e.g. sandwiching) the eyepiece 221 with frame 214. Similarly to the implementations of FIGS. 3A-3F, the potential advantages of the implementations of FIGS. 4A-4F include increase rigidity, thinner form-factor, lighter form-factor, fewer assembly steps, and increased robustness of the device against damages from drops. Furthermore, the implementations of FIGS. 4A-4F also facilitate an improved sealing of the optical components from contaminants such as dust, dirt, and moisture.

FIG. 4B illustrates a top view of structure 480, in accordance with aspects of the disclosure. Structure 480 includes a first temporal side 431 of structural frame 410, a nasal portion 435 of structural frame 410, and a second temporal side 439 of structural frame 410. As shown in FIGS. 4A and 4B, the structural frame 410 may extend to a temporal side of an HMD and extend to a nasal portion of the HMD.

World-side lens 420A is disposed between first temporal side 431 of structural frame 410 and the nasal portion 435 of the structural frame 410. In the implementation of FIG. 4B, world-side lens 420A is contiguous with first temporal side 431 and nasal portion 435. In some implementations, world-side lens 420A is integrated with, and contiguous with, either the first temporal side 431 of the structural frame 410 or the nasal portion 435 of structural frame 410. In some implementations, the world-side lens 420A is molded into a contiguous part with all or a portion of structural frame 410 by providing an optically transparent refractive material to a mold that includes the desired shape and curvature of world-side lens 420A. Dimension 493 illustrates a thickness dimension of world-side lens 420A. Dimension 493 may be 0.8 mm or thinner, in some implementations. Dimension 493 may be 0.6 mm or thinner, in some implementations. World-side lens 420B may have similar thickness dimensions.

World-side lens 420B is disposed between second temporal side 439 of structural frame 410 and the nasal portion 435 of the structural frame 410. In the implementation of FIG. 4B, world-side lens 420B is contiguous with second temporal side 439 and nasal portion 435. In some implementations, world-side lens 420B is integrated with, and contiguous with, either the second temporal side 439 of the structural frame 410 or the nasal portion 435 of structural frame 410. In some implementations, the world-side lens 420B is molded into a contiguous part with all or a portion of structural frame 410 by providing an optically transparent refractive material to a mold that includes the desired shape and curvature of world-side lens 420B. In some implementations, structure 480 is fabricated using a single mold.

FIG. 4B illustrates that the world-side lens 420A integrated with all or a portion of structural frame 410 may include a mounting feature 432 for positioning a waveguide and/or a mounting feature 434 to position an eye-side lens. Similarly, world-side lens 420B integrated with all or a portion of structural frame 410 may include a mounting feature 438 for positioning a waveguide and/or a mounting feature 436 to position an eye-side lens.

FIG. 4C illustrates a structure 481 having waveguides 450A and 450B included with structure 480, in accordance with aspects of the disclosure. Waveguide 450A is disposed on mounting feature 432. Mounting feature 432 may be an optical bench feature configured to align waveguide 450A. Waveguide 450A may be adhered to the mounting feature 432 included in the nasal portion 435 of the structural frame 410. Waveguide 450A may be optically coupled to receive display light generated by display engine 440A and direct the display light to an eyebox region as display light 455A in order to present a virtual image to a user. In some implementations, waveguide 450A and display engine 440A form a display assembly that is assembled as a single part into structure 481. Structure 481 may include a cavity sized to hold and secure display engine 440A and waveguide 450A.

Waveguide 450B is disposed on mounting feature 438. Mounting feature 438 may be an optical bench feature configured to align waveguide 450B. Waveguide 450B may be adhered to the mounting feature 438 included in the nasal portion 435 of the structural frame 410. Waveguide 450B may be optically coupled to receive display light generated by display engine 440B and direct the display light to an eyebox region as display light 455B in order to present a virtual image to a user. In some implementations, waveguide 450B and display engine 440B form a display assembly that is assembled as a single part into structure 481. Structure 481 may include a cavity sized to hold and secure display engine 440B and waveguide 450B.

FIG. 4D illustrates a structure 482 having eye-side lenses 460A and 460B included with structure 481, in accordance with aspects of the disclosure. Eye-side lens 460A is disposed on mounting feature 434. Mounting feature 434 may be an optical bench feature configured to align eye-side lens 460A. Eye-side lens 460A may be adhered to the mounting feature 434 included in the nasal portion 435 of the structural frame 410. Waveguide 450A is disposed between world-side lens 420A and eye-side lens 460A, in FIG. 4D. Airgaps may exist between waveguide 450A and world-side lens 420A. Airgaps may exist between waveguide 450A and eye-side lens 460A.

Eye-side lens 460A is configured to have an optical power configured to focus the display light 455A to an eyebox region. Eye-side lens 460A may be a planar-concave lens and the curvature of the concave (eye-side) portion of the planar-concave lens may provide the optical power. The optical power of the eye-side lens may include a prescription optical power that is customized for the user, in some implementations. Eye-side lens 460A may be optically aligned to share a common optical axis with world-side lens 420A.

Eye-side lens 460B is disposed on mounting feature 436. Mounting feature 436 may be an optical bench feature configured to align eye-side lens 460B. Eye-side lens 460B may be adhered to the mounting feature 436 included in the nasal portion 435 of the structural frame 410. Waveguide 450B is disposed between world-side lens 420B and eye-side lens 460B, in FIG. 4D. Airgaps may exist between waveguide 450B and world-side lens 420B. Airgaps may exist between waveguide 450B and eye-side lens 460B.

Eye-side lens 460B is configured to have an optical power configured to focus the display light 455B to an eyebox region. Eye-side lens 460B may be a planar-concave lens and the curvature of the concave (eye-side) portion of the planar-concave lens may provide the optical power. The optical power of the eye-side lens may include a prescription optical power that is customized for the user, in some implementations. The optical power of eye-side lens 420B may differ from the optical power of eye-side lens 420A. Eye-side lens 460B may be optically aligned to share a common optical axis with world-side lens 420B.

FIG. 4E illustrates an assembly 483 for a head-mounted display having one or more aesthetic covers added to structure 482, in accordance with aspects of the disclosure. FIG. 4E includes aesthetic cover piece 471 over a first temporal side 431 of structure 480, nasal aesthetic piece 472 over nasal portion 435 of structure 480, and aesthetic cover piece 473 over a second temporal side 439 of structure 480. In the illustration of FIG. 4E, the aesthetic covers 471, 472, and 473 are not disposed over the world-side lenses 420A/420B nor the eye-side lenses 460A/460B so that they don’t block scene light 491 from propagating through the lenses. In some implementations, the aesthetic covers 471, 472, and/or 473 may include a coating or a paint. In some implementations, the aesthetic covers 471, 472, and/or 473 may simply be a coating or paint.

In FIG. 4E, eye-side lens 460A may have an optical power that combines with the optical power of world-side lens 420A to focus scene light 491 to an eyebox region 489A. In some implementations, the optical power of the world-side lens 420A offsets the optical power of eye-side lens 460A so that no optical power is imparted to scene light 491 after propagating through both world-side lens 420A and eye-side lens 460A. World-side lens 420B may have an optical power that combines with the optical power of eye-side lens 460B to focus scene light 491 to an eyebox region 489B. In some implementations, the optical power of the world-side lens 420B offsets the optical power of eye-side lens 460B so that no optical power is imparted to scene light 491 after propagating through both world-side lens 420B and eye-side lens 460B.

FIG. 4F illustrates a head-mounted display (HMD) 400 including assembly 483, in accordance with aspects of the disclosure. In FIG. 4F, foldable arms 404A and 404B are coupled to the temporal sides of the structural frame 410 of assembly 483. Assembly 483 and arms 404A and 404B may include supporting hardware of HMD 400 such as processing logic 407, a wired and/or wireless data interface for sending and receiving data, graphic processors, and one or more memories for storing data and computer-executable instructions. Processing logic 407 may include circuitry, logic, instructions stored in a machine-readable storage medium, ASIC circuitry, FPGA circuitry, and/or one or more processors. In one embodiment, HMD 400 may be configured to receive wired power. In one embodiment, HMD 400 is configured to be powered by one or more batteries. In one embodiment, HMD 400 may be configured to receive wired data including video data via a wired communication channel. In one embodiment, HMD 400 is configured to receive wireless data including video data via a wireless communication channel. Processing logic 407 may be communicatively coupled to a network 487 to provide data to network 487 and/or access data within network 487. The communication channel between processing logic 407 and network 487 may be wired or wireless.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 107, 307, or 407) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A head-mounted display comprising:
a structural frame;
a waveguide configured to direct display light to an eyebox region;
an eye-side lens integrated with the structural frame as a molded contiguous refractive material, wherein the eye-side lens has a first optical power configured to focus the display light to the eyebox region; and
a world-side lens having a second optical power, wherein the combination of the first optical power and the second optical power focuses scene-light to the eyebox region, the waveguide disposed between the eye-side lens and the world-side lens.

2. The head-mounted display of claim 1, wherein the eye-side lens integrated with the structural frame includes a mounting feature to position the waveguide.

3. The head-mounted display of claim 1 further comprising:
a second waveguide configured to direct second display light to a second eyebox region; and
a second eye-side lens integrated with the structural frame and the eye-side lens as the molded contiguous refractive material, wherein the second eye-side lens is configured to focus the second display light to the second eyebox region.

4. The head-mounted display of claim 3, wherein the structural frame integrated with the eye-side lens and the second eye-side lens is coupled to foldable arms of the head-mounted display, the foldable arms coupled to the structural frame on temporal sides of the structural frame.

5. The head-mounted display of claim 1, wherein the structural frame extends to a temporal side of the head-mounted display and extends to a nasal side of the head-mounted display.

6. The head-mounted display of claim 1, wherein the eye-side lens is 0.8 mm or thinner.

7. The head-mounted display of claim 1, wherein the first optical power offsets the second optical power.

8. The head-mounted display of claim 1 further comprising:
an aesthetic cover disposed over the structure frame but not disposed over the eye-side lens nor over the world-side lens.

9. The head-mounted display of claim 1 further comprising:
a display engine configured to direct the display light into the waveguide.

10. The head-mounted display of claim 1, wherein the eye-side lens integrated with the structural frame includes a mounting feature to position the world-side lens.

11. An assembly for a head-mounted display comprising:
a structural frame; and
an eye-side lens integrated with the structural frame as a molded contiguous refractive material, wherein the eye-side lens has a first optical power configured to focus the display light to an eyebox region,
wherein the eye-side lens integrated with the structural frame includes a mounting feature to position a waveguide to direct display light through the eye-side lens to the eyebox region.

12. The assembly of claim 11 further comprising:
a second eye-side lens integrated with the structural frame and the eye-side lens as the molded contiguous refractive material, wherein the second eye-side lens includes a second mounting feature to position a second waveguide to direct second display light through the second eye-side lens to a second eyebox region.

13. A head-mounted display comprising:
a structural frame;
a waveguide configured to direct display light to an eyebox region;
a world-side lens integrated with the structural frame as a molded contiguous refractive material; and
an eye-side lens having a first optical power configured to focus the display light to the eyebox region, wherein the world-side lens has a second optical power, and wherein the combination of the first optical power and the second optical power focuses scene-light to the eyebox region, the waveguide disposed between the eye-side lens and the world-side lens.

14. The head-mounted display of claim 13, wherein the world-side lens integrated with the structural frame includes a mounting feature to position the waveguide.

15. The head-mounted display of claim 13 further comprising:
a second waveguide configured to direct second display light to a second eyebox region; and
a second world-side lens integrated with the structural frame and the world-side lens as the molded contiguous refractive material, wherein the second world-side lens is configured to focus the second display light to the second eyebox region.

16. The head-mounted display of claim 15, wherein the structural frame integrated with the world-side lens and the second world-side lens is coupled to foldable arms of the head-mounted display, the foldable arms coupled to the structural frame on temporal sides of the structural frame.

17. The head-mounted display of claim 13, wherein the structural frame extends to a temporal side of the head-mounted display and extends to a nasal side of the head-mounted display.

18. The head-mounted display of claim 13, wherein the world-side lens is 0.8 mm or thinner.

19. The head-mounted display of claim 13, wherein the first optical power offsets the second optical power.

20. The head-mounted display of claim 13 further comprising:
an aesthetic cover disposed over the structure frame but not disposed over the eye-side lens nor over the world-side lens.
